(19) United States
(12) Patent Application Publication
(10) Pub. No.: US 2025/0259999 A1
(43) Pub. Date: Aug. 14, 2025

(54) COMPOSITE ELECTRODES WITH MULTILAYER COATINGS

(71) Applicant: UChicago Argonne, LLC, Chicago, IL (US)

(72) Inventors: Guiliang Xu, Naperville, IL (US); Jieun Lee, Woodridge, IL (US); Khalil Amine, Oakbrook, IL (US)

(73) Assignee: UChicago Argonne, LLC, Chicago, IL (US)

(21) Appl. No.: 18/440,838

(22) Filed: Feb. 13, 2024

(51) Int. Cl. H01M 4/36; H01M 4/136; H01M 4/62; H01M 10/0562

(52) U.S. Cl. CPC H01M 4/366; H01M 4/136; H01M 4/625; H01M 10/0562; H01M 2300/008

(57) ABSTRACT

A solid electrode includes particles of an electroactive material, a solid electrolyte comprising particles of an ionic conducting compound having at least one halogen element, a conductive carbon, and a coating deposited on the particles of the electroactive material, the particles of the solid electrolyte, or a combination thereof. The coating includes a metal halide, a metal sulfide, a metal phosphide, a metal oxide, a metal selenide, or a combination of two or more thereof. A method for preparing the solid electrode includes milling a mixture of the electroactive material, the conductive carbon, and the solid electrolyte to produce the coated solid electrode material comprising the coating derived from decomposition products of the ionic conducting compound, the coating deposited on the particles of the electroactive material, the solid electrolyte, or a combination thereof.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology relates generally to the field of solid-state rechargeable batteries, and more specifically is related to composite solid-state electrodes for rechargeable batteries.

### BACKGROUND

There is a growing demand for advanced battery technologies capable of powering, for example, vehicles, planes, and consumer electronics. This demand has brought attention to concerns such as energy density, safety, and supply chain risks associated with conventional rechargeable batteries, emphasizing the need for next-generation battery systems that can provide substantially improved energy density while maintaining economic viability and safety.

### SUMMARY

In an aspect, a solid electrode includes particles of an electroactive material, a solid electrolyte including particles of an ionic compound having at least one halogen element, a conductive carbon, and a coating deposited on the particles of the electroactive material, the particles of the solid electrolyte, or a combination thereof. The coating includes a first layer comprising a metal halide, a metal sulfide, a metal phosphide, a metal oxide, or a metal selenide; a second layer comprising a metal halide, a metal sulfide, a metal phosphide, a metal oxide, or a metal selenide. The first layer is different than the second layer.

In any embodiment, the first layer of the coating may include a metal halide layer deposited on the particles of the electroactive material, the particles of the solid electrolyte, or a combination thereof; the second layer of the coating may include a metal sulfide layer, a metal oxide layer, or a metal selenide layer deposited on the first layer; and the coating may include a third layer including a metal phosphide layer deposited on the second layer. The metal halide may include LiCl, LiBr, LiI, or LiF. The metal sulfide may include Li₂S. The metal phosphide may include Li₃P. The coating may be deposited on the particles of the electroactive material and the particles of the solid electrolyte. The coating may have a thickness of about 0.1 nm to about 100 nm.

In any embodiment, the particles of the solid electrolyte may include an argyrodite-type inorganic solid electrolyte. The argyrodite-type inorganic solid electrolyte may have a formula of Li₂S—P₂S₅—LiX, Li₂S—YS_{1.5}—LiX, Li₂S—YS₂—LiX, Li₂S—P₂S₅—YS₂—LiX, or Li₆PS₅X; where X is F, Cl, Br, I, or a combination of two or more thereof; and Y is Si, Ge, Sn, W, Sb, Al, As, B, Ga, or a combination of two or more thereof. The particles of the electroactive material may include sulfur, selenium, tellurium, metal sulfide, metal selenide, metal fluoride, or a combination of two or more thereof. The particles of the electroactive material may include tin, silicon, germanium, phosphorus, antimony, lead, graphite, hard carbon, lithium titanate, or a combination of two or more thereof.

The conductive carbon may include a first carbon phase and a second carbon phase. The first carbon phase may include graphite, graphene, reduced graphene oxide, a first type of carbon black, a metal-organic framework, carbon spheres, carbon aerogel, a first type of carbon nanotubes, or a first type of carbon nanofibers. The second carbon phase may include a second type of carbon black, a second type of carbon nanotubes, a second type of carbon nanofibers, polypyrrole, polyaniline, poly(3,4-etheylenedioxythiophene), poly(3,4-ethylenedioxythiophene), or polystyrene sulfonate.

In another aspect an electrochemical cell includes a first electrode, a second electrode, and a solid electrolyte membrane deposited between the first electrode and the second electrode. The first electrode includes particles of an electroactive material, a first solid electrolyte comprising an ionic conducting compound with at least one halogen element, a conductive carbon, and a coating deposited on the particles of the electroactive material, the first solid electrolyte, or a combination thereof. The coating includes a first layer comprising a metal halide, a metal sulfide, a metal phosphide, a metal oxide, or a metal selenide; a second layer comprising a metal halide, a metal sulfide, a metal phosphide, a metal oxide, or a metal selenide. The first layer is different than the second layer. The solid electrolyte membrane includes a second solid electrolyte.

The ionic conducting compound may include an argyrodite-type inorganic solid electrolyte. The second solid electrolyte may include a perovskite, an anti-perovskite, a NASICON-type oxide, a garnet-type oxide, a thio-LISCON sulfide, a glass sulfide, an argyrodite-type inorganic solid electrolyte, a halide, a polymer, or a combination of two or more thereof. In any embodiment, the second solid electrolyte may be the same as or different than the first solid electrolyte.

In any embodiment, the particles of the electroactive material may include sulfur, selenium, tellurium, metal sulfide, metal selenide, metal fluoride, or a combination of two or more thereof; and the second electrode may include lithium, lithium-indium alloy, lithium-silicon alloy, lithium-tin alloy, lithium-germanium alloy, lithium-phosphorus alloy, lithium-antimony alloy, lithium-bismuth alloy, lithium-lead alloy, lithiated hard carbon, lithiated graphite, or a combination thereof.

In any embodiment, the electroactive material may include tin, silicon, germanium, phosphorus, antimony, bismuth, lead, graphite, hard carbon, lithium titanate, or a combination of two or more thereof; and the second electrode may include a layered lithium nickel manganese cobalt oxide having a formula of Li_{1+δ}NiₓMn_{y}Co₂O₂ where δ≥0 and x+y+z=1; a layered lithium nickel cobalt aluminum oxide having a formula of LiNiₓCo_{y}Al_{z}O₂ where x+y+z=1; a spinel lithium nickel manganese oxide having a formula of LiNiₓMn₂₋ₓO₄, wherein 0≤x≤2; LiFePO₄; LiNiPO₄; LiMnₓFe₁₋ₓPO₄; LiCoPO₄; or a combination of any two or more thereof.

In another aspect, a method of preparing a coated solid electrode material includes milling a mixture of an electroactive material comprising particles, a conductive carbon, and a solid electrolyte comprising at least one halogen element to produce the coated solid electrode material comprising a coating derived from decomposition products of the solid electrolyte. The coating is deposited on the particles of the electroactive material, the solid electrolyte, or a combination thereof.

In any embodiment, milling may include milling in a planetary mixer at a mixing speed of about 2000 rpm to about 5000 rpm for a mixing time of about 5 hours to about 10 hours. The method may further include compressing the coated solid electrode material into a cohesive mass. The solid electrolyte may include an argyrodite-type inorganic solid electrolyte. The coating may include a first layer comprising a metal halide, a metal sulfide, a metal phosphide, a metal oxide, or a metal selenide; and a second layer comprising a metal halide, a metal sulfide, a metal phosphide, a metal oxide, or a metal selenide. The first layer may be different than the second layer. Milling the mixture may include mixing the electroactive material, the solid electrolyte, and the conductive carbon in a weight ratio of about 23 wt. % electroactive material, 50 wt. % solid electrolyte, and 27 wt. % conductive carbon.

### BRIEF DESCRIPTION OF THE DRAWINGS

FIG. 1 is an illustration of a composite electrode material including particles of electroactive material coated with a multilayer coating and particles of solid electrolyte coated with the multilayer coating.

FIG. 2 is a graph of X-ray diffraction patterns of different composite electrode materials with multilayer coatings, where “SE” represent the solid electrolyte.

FIG. 3A is a scanning electron microscopy (SEM) image of an electrode composite material including sulfur electroactive material coated with a multilayer coating, argyrodite solid electrolyte coated with the multilayer coating, and conductive carbon.

FIG. 3B is a sulfur elemental map of the image in FIG. 3A.

FIG. 3C is a phosphorus elemental map of the image in FIG. 3A.

FIG. 3D is a chlorine elemental map of the image in FIG. 3A.

FIG. 4A is an SEM image of an electrode composite material including selenium electroactive material coated with a multilayer coating, argyrodite solid electrolyte coated with the multilayer coating, and conductive carbon.

FIG. 4B is a sulfur elemental map of the image in FIG. 4A.

FIG. 4C is a phosphorus elemental map of the image in FIG. 4A.

FIG. 4D is a chlorine elemental map of the image in FIG. 4A.

FIG. 4E is a selenium elemental map of the image in FIG. 4A.

FIG. 5 is a transmission electron microscopy (TEM) image of an electrode composite material including selenium coated with a multilayer coating, argyrodite solid electrolyte coated with the multilayer coating, and conductive carbon.

FIG. 6A is a TEM image of another composite electrode material including selenium coated with a multilayer coating, argyrodite solid electrolyte coated with the multilayer coating, and carbon.

FIG. 6B is a graph of elemental mapping across a cross-section of the TEM image in FIG. 6A.

FIG. 7A is a high-angle annular diffraction (HAADF) TEM image and elemental mapping of Li₂S—P₂S₅—LiCl solid electrolyte.

FIG. 7B is a HAADF TEM image and elemental mapping of an electrode composite material including selenium electroactive material coated with a multilayer coating, Li₂S—P₂S₅—LiCl solid electrolyte coated with the multilayer coating, Ketjen Black conductive carbon, and super C45 conductive carbon according to Example 10.

FIG. 7C is a HAADF TEM image and elemental mapping of an electrode composite material including selenium electroactive material coated with a multilayer coating, Li₂S—P₂S₅—LiBr solid electrolyte coated with the multilayer coating, Ketjen Black conductive carbon, and super C45 conductive carbon according to Example 11.

FIG. 7D is a HAADF TEM image and elemental mapping of an electrode composite material including SeS₂ electroactive material coated with a multilayer coating, Li₂S—P₂S₅—LiCl solid electrolyte coated with the multilayer coating, Ketjen Black conductive carbon, and super C45 conductive carbon according to Example 12.

FIG. 8 is a graph of charge/discharge curves for an electrode composite material including sulfur coated with a multilayer coating, argyrodite solid electrolyte coated with the multilayer coating, and carbon with 4 mg/cm² sulfur loading cycled at a rate of C/10.

FIG. 9 is a graph of cycling performance of an electrode composite material including sulfur coated with a multilayer coating, argyrodite solid electrolyte coated with the multilayer coating, and carbon according to Example 1 with 4 mg/cm² sulfur loading cycled at a rate of C/10.

FIG. 10A is a graph of first charge/discharge curves for electrode composite materials including sulfur coated with a multilayer coating, argyrodite solid electrolyte coated with the multilayer coating, and carbon prepared with different high-energy milling times according to Examples 1-3 with 4 mg/cm² sulfur loading cycled at a rate of C/10.

FIG. 10B is a graph of second charge/discharge curves for the electrodes in FIG. 10A.

FIG. 10C is a graph of fiftieth charge/discharge curves for the electrodes in FIG. 10A.

FIG. 11 is a graph of cycling performance of the electrodes in FIG. 10A.

FIG. 12 is a graph of the linear fits of peak current at different scan rates of performance of the electrodes in FIGS. 10A-10C.

FIG. 13 is a graph of the cycle performance of electrode composite materials including sulfur coated with a multilayer coating, argyrodite solid electrolyte coated with the multilayer coating, and either super C45 conductive carbon or Ketjen Black conductive carbon according to Examples 4 and 5, respectively, with 4 mg/cm² sulfur loading cycled at a rate of C/10.

FIG. 14 is a graph of the cycle performance of electrode composite materials including sulfur coated with a multilayer coating, argyrodite solid electrolyte coated with the multilayer coating, and conductive carbon comparing different argyrodite solid electrolyte materials according to Examples 6-9, with 4 mg/cm² sulfur loading cycled at a rate of C/10.

FIG. 15 is a graph of charge/discharge curves of electrode composite materials including selenium coated with a multilayer coating, argyrodite solid electrolyte coated with the multilayer coating, and conductive carbon according to Example 10 with 4 mg/cm² selenium loading cycled at a rate of C/10.

FIG. 16 is a graph of the cycle performance of the electrode in FIG. 15.

FIG. 17 is a graph of charge/discharge curves of electrode composite materials including SeS₂ coated with a multilayer coating, argyrodite solid electrolyte coated with the multilayer coating, and conductive carbon with 4 mg/cm² SeS₂ loading cycled at a rate of C/10.

FIG. 18 is a graph of the cycle performance of the electrode in FIG. 17.

FIG. 19 is a graph of charge/discharge curves of electrode composite materials including tin coated with a multilayer coating, argyrodite solid electrolyte coated with the multilayer coating, and conductive carbon according to Example 13 with 4 mg/cm² tin loading cycled at a rate of C/10.

FIG. 20 is a graph of cycle performance of the electrode in FIG. 19.

FIG. 21 is a graph of charge/discharge curves of an electrode composite material including sulfur, argyrodite solid electrolyte, and carbon according to Comparative Example 1 with 4 mg/cm² sulfur loading cycled at a rate of C/10.

FIG. 22 is a graph of the cycle performance of the electrode in FIG. 21 at a rate of C/10.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The term “argyrodite-type” (also referred to herein as “argyrodite”) refers to the category of materials having a similar structure to silver germanium sulfide mineral (Ag₈GeS₆) commonly referred to as argyrodite mineral. The argyrodite-type inorganic solid electrolyte may have a formula of Li₂S—P₂S₅—LiX, Li₂S—YS_{1.5}—LiX, Li₂S—YS₂—LiX, Li₂S—P₂S₅—YS₂—LiX, or Li₆PS₅X; where X is F, Cl, Br, I, or a combination of two or more thereof; and Y is Si, Ge, Sn, W, Sb, Al, As, B, Ga, or a combination of two or more thereof. In some embodiments, the general chemical formula for the class of argyrodite solid electrolytes can be written as M-P—S—X (where M=Li, Mg, Na, Ca, and X=halide such as F, Br, Cl, I). More specifically, the argyrodite materials may be superionic conductors taking the form of Li₇₋ₓBCh₆₋ₓXₓ, where 0<x<1, B is phosphorous or arsenic, Ch is a chalcogen such as sulfur, oxygen, or selenium, and X is a halide (e.g., F, Cl, Br, or I). For example, lithium argyrodites with the composition of Li₆PS₅Cl have exhibited a high ionic conductivity of up to 1.5×10⁻² S/cm, which is several orders better than the best known LiPON material ionic conductivity (˜10⁻⁶ S/cm) at room temperature.

Electroactive materials with high specific capacity, such as sulfur, selenium, tellurium, metal sulfides, metal fluorides, alloy-based anode (e.g., Si, Sn, P, Ge, Pb, Bi, Sb), graphite, hard carbon, lithium titanate, and composites made of two or more thereof are of interest for next-generation battery systems. There has also been interest in the development of solid-state batteries. Solid-state batteries may mitigate or prevent fire risks of conventional lithium-ion batteries originating from the use of flammable organic solvents in liquid electrolytes.

Conventional solid-state batteries may include one or more composite electrode materials in one or both electrodes. Conventionally, these composite electrode materials are fabricated via physical mixing of an electroactive material, a solid-state electrolyte, and a conductive carbon. Because of the way they are mixed, these conventional composite electrode materials include numerous triple-phase boundaries at solid-solid interfaces between particles of active material, conductive carbon, and solid-state electrolyte. These triple-phase boundaries often have sluggish ion transport that significantly limits the reversibility and kinetics of battery cycling. Furthermore, reversibility and kinetics may be further degraded through volume changes (e.g., up to about 500%) of the electroactive materials resulting from lithiation and de-lithiation. Previous attempts to address these issues with reversibility and kinetics of composite electrode materials have typically included additional fabrication steps to create more complex structures (e.g., sulfur encapsulated into nanostructured carbon hosts), which significantly increases fabrication cost and time. Because of these limitations, there is a need for better solid-state batteries. The present inventors recognized that a composite electrode material with a different interface may address some or all of these issues.

Disclosed herein are composite electrode materials having multilayer coatings, electrodes made with the composite electrode materials, solid-state batteries made with the composite electrode materials, and methods of preparing the composite electrode materials. The composite electrode materials include electroactive material particles (also referred to herein as powders), solid electrolyte particles, and a coating deposited on the electroactive material particles, solid electrolyte particles, or a combination of both the electroactive material particles and the solid electrolyte particles. The coating is formed by milling a mixture of the electroactive material particles, the solid electrolyte particles, and conductive carbon at a speed sufficient to cause partial degradation of the solid electrolyte, where the coating is derived from these degradation products of the solid electrolyte. The coating facilitates ion transport at the triple-phase boundaries and may suppress volume changes during charge/discharge to increase reversibility and kinetics of battery operation. The coating may suppress further decomposition of the solid electrolyte in the composite electrode material and/or increase utilization of the electroactive material (for example, 95% to 100% utilization). This method of forming the composite electrode material may reduce fabrication cost and time while increasing electrode stability and capacity.

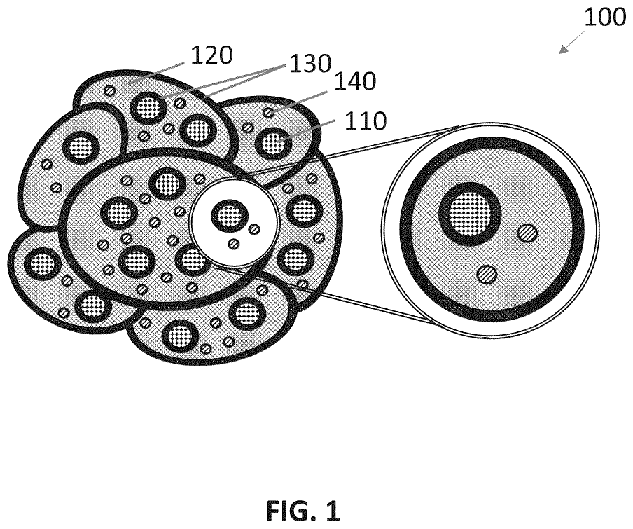

FIG. 1 is an illustration of a composite electrode material 100 including particles of electroactive material 110 coated with a multilayer coating 130 and particles of solid electrolyte 120 coated with the multilayer coating 130. The composite electrode material also includes conductive carbon 140.

The solid electrolyte particles in the composite electrode material include an ionic conducting compound having a chemical formula with at least one halogen element. For example, the ionic conducting compound may include an argyrodite-type inorganic solid electrolyte. The argyrodite-type inorganic solid electrolyte may have a formula of Li₂S—P₂S₅—LiX, Li₂S—YS_{1.5}—LiX, Li₂S—YS₂—LiX, Li₂S—P₂S₅—YS₂—LiX, Li₆PS₅X, or a combination of two or more thereof; where X is F, Cl, Br, I, or a combination of two or more thereof; and Y is Si, Ge, Sn, W, Sb, Al, As, B, Ga, or a combination of two or more thereof. For example, the solid electrolyte particles may include Li₆PS₅Cl, Li₆PS₅Br, Li₆PS₅I, Li₆PS₅ClₓBr₁₋ₓ, Li₆PS₅Cl_{y}I_{1-y}, and Li₆PS₅Br_{z}I_{1-z}, Li₂S—P₂S₅—LiCl, Li₂S—P₂S₅—LiBr, Li₂S—P₂S₅—LiI, Li₂S—P₂S₅—LiCl—LiI, Li₂S—P₂S₅—LiCl—LiBr, Li₂S—P₂S₅—LiI—LiBr, or a combination of two or more thereof.

Illustrative examples of the solid electrolyte particles include Li₂S—P₂S₅—LiF, Li₂S—P₂S₅—LiCl, Li₂S—P₂S₅—LiBr, Li₂S—P₂S₅—LiI, Li₂S—P₂S₅—Li₂O—LiF, Li₂S—P₂S₅—Li₂O—LiCl, Li₂S—P₂S₅—Li₂O—LiBr, Li₂S—P₂S₅—Li₂O—LiI, Li₂S—SiS₂—LiF, Li₂S—SiS₂—LiCl, Li₂S—SiS₂—LiBr, Li₂S—SiS₂—LiI, Li₂S—SiS₂—B₂S₃—LiF, Li₂S—SiS₂—B₂S₃—LiCl, Li₂S—SiS₂—B₂S₃—LiBr, Li₂S—SiS₂—B₂S₃—LiI, Li₂S—SiS₂—P₂S₅—LiF, Li₂S—SiS₂—P₂S₅—LiCl, Li₂S—SiS₂—P₂S₅—LiBr, Li₂S—SiS₂—P₂S₅—LiI, Li₂S—GeS₂—LiF, Li₂S—GeS₂—LiCl, Li₂S—GeS₂—LiBr, Li₂S—GeS₂—LiI, and combinations or any two or more thereof. In some embodiments, the solid electrolyte particles include one or more of Li₂S—P₂S₅—LiCl, Li₂S—P₂S₅—LiBr, and Li₂S—P₂S₅—LiI.

The solid electrolyte particles may have an average particle size of about 50 nm to 50 μm. For example, the average particle size may be about 100 nm to about 50 μm, about 1 μm to about 40 μm, about 10 μm to about 30 μm, about 20 μm to about 50 μm, about 30 μm to about 50 μm, or about 40 μm to about 50 μm. The solid electrolyte particles may include a crystalline phase, a nanocrystalline phase, an amorphous phase, or a combination of two or more thereof. In some embodiments, the solid electrolyte may be crystalline or nanocrystalline.

The solid electrolyte in the composite electrode material may be present in an amount of about 10% to about 95% by weight (% wt.) of the total weight of the composite electrode material. For example, the electroactive material may be present at about 20% wt. to about 90% wt., about 30% wt. to about 80% wt., about 40% wt. to about 60% wt., or about 50% wt.

The composite electrode material may include a mixture of amorphous and nanocrystalline phase materials and crystalline phase materials. Without being bound by any theory, the amorphous/nanocrystalline phase may be primarily from the electroactive material and the crystalline phase may be primarily from the solid electrolyte material and the coating.

The coating may include multiple layers forming a multilayer coating. The coating may include, for example, two layer, three layers, four layers, or five layers, where each layer is different. In some embodiments, instead of having distinct boundaries, the layers in the multilayer coating may form a gradient composition, with mixing or blending at the interface between different layers. This mixing or blending may increase ion transport across interfaces.

As the coating is derived from the decomposition of the solid electrolyte in the composite electrode material, the coating may include some or all of the same elements as the solid electrolyte. The coating may include a metal halide, a metal sulfide, a metal phosphide, a metal oxide, a metal selenide, or a combination of two or more thereof. For example, the coating may include a lithium halide, a lithium sulfide, a lithium phosphide, a lithium selenide, a lithium oxide, or a combination of two or more thereof. The lithium halide may include LiCl, LiBr, LiI, LiF, or a combination of two or more thereof. The lithium sulfide may include Li₂S. The lithium phosphide may be Li₃P. In some embodiments, the solid electrolyte contains transition metal dopants including but not limited to Si, Ge, Sn, W, Sb, Al, As, and Ga. Thus, the coating may include the transition metal dopant elements in the form of the metal halide, metal sulfide, metal phosphide, metal oxide, or metal selenide of the coating. In some embodiments, the coating may include a single layer including one or more of metal halides, metal sulfides, metal phosphides, metal oxides, and/or metal selenides, where components are dispersed in one another to form a single phase. In some embodiments, the coating may include at least two layers. Each layer may include metal halide, metal sulfide, metal phosphide, metal oxide, metal selenide, or a combination of two or more thereof, where each layer has a different composition.

As an example, the coating may include a metal halide layer deposited on the particles of the electroactive material, the particles of the solid electrolyte, or a combination thereof; a metal sulfide layer, a metal oxide layer, or a metal selenide layer deposited on the metal halide layer; and a metal phosphide layer deposited on the metal sulfide layer or the metal selenide layer. For example, the coating may include a lithium chloride layer deposited on the particles of the electroactive material, the particles of the solid electrolyte, or a combination thereof; a lithium sulfide layer, a lithium selenide layer, or a combination thereof deposited on the lithium chloride layer; and a lithium phosphide layer deposited on the lithium sulfide layer, the lithium oxide layer, the lithium selenide layer, or the combination thereof.

The coating may be deposited on particles of the electroactive material, particles of the solid electrolyte, or the combination thereof. In some embodiments, the coating is deposited primarily on the particles of the electroactive material. In some embodiments, the coating is deposited primarily on the particles of the solid electrolyte. In some embodiments, the coating is deposited on both the particles of the electroactive material and the particles of the solid electrolyte. The coating may be crystalline, nanocrystalline, amorphous, or a combination of two or more thereof. In some embodiments, the coating may be crystalline or nanocrystalline.

The coating may have a total thickness of about 0.1 nm to about 100 nm. The coating may have a total thickness of about 100 nm or less. For example, the coating may have a total thickness of about 0.1 nm to about 80 nm, 0.1 nm to about 50 nm, 0.1 nm to about 20 nm, about 0.1 nm to about 10 nm, about 1 nm to about 10 nm, or about 1 nm to about 5 nm. The coating may include multiple layers, where each layer has a thickness of about 0.1 nm to about 50 nm. For example, a layer of the coating may have a total thickness of about 0.1 nm to about 20 nm, 0.1 nm to about 10 nm, 0.1 nm to about 5 nm, about 1 nm to about 10 nm, or about 1 nm to about 5 nm.

In any embodiment, the coatings may include an outer coating layer of polymer, such as poly(3,4-ethylenedioxythiophene), polypyrrole, polyaniline, or a copolymer or blend of two or more thereof. The polymer coating layer may be deposited via gas-phase reaction to cover the electroactive material, the solid electrolyte, the conductive carbon, or a combination of two or more thereof. The thickness of the polymer coating may be about 0.1 nm to about 10 nm.

The electroactive material in the composite electrode material includes particles of electroactive material. The electroactive material may be a cathode electroactive material, forming a composite cathode material. For example, the composite electrode material may be a composite cathode material and the particles of the electroactive material may include sulfur, selenium, tellurium, metal sulfide, metal selenide, metal fluoride, or a combination of two or more thereof. The metal element in the metal sulfide, metal selenide, and/or metal fluoride may be lithium. The electroactive material may be an anode electroactive material, forming a composite anode material. For example, the composite electrode material may be a composite anode material and the particles of the electroactive material may include tin, silicon, germanium, phosphorus, antimony, lead, bismuth, graphite, hard carbon, lithium titanate, or a combination of two or more thereof.

The electroactive material may be in the form of particles. The particles of the electroactive material may have an average particle size of about 10 nm to about 5 μm. For example, the particles of the electroactive material may have an average particle size of about 10 nm to about 3 μm, 20 nm to about 1 μm, 20 nm to about 500 nm, about 50 nm to about 250 nm, about 100 nm to about 250 nm, about 150 nm to about 250 nm, or about 200 nm to about 250 nm. The particles of the electroactive material may be crystalline, nanocrystalline, amorphous, or a combination of two or more thereof.

The electroactive material may be present in the composite electrode material in an amount of about 1% wt. to about 70% wt. of the total weight of the composite electrode material. For example, the electroactive material may be present at about 5% wt. to about 60% wt., about 10% wt. to about 50% wt., about 15% wt. to about 40% wt., or about 20% wt. to about 30% wt.

The conductive carbon in the composite electrode material may be present as a single phase or multiple phases. Multiple phases may include two, three, four, or five different forms of conductive carbon. In some embodiments, composite electrode materials with dual phase conductive carbon have higher capacity and stability as compared to composite electrode materials with single phase conductive carbon.

The conductive carbon may include graphite, graphene, holey graphene, expanded graphite, reduced graphene oxide, acetylene black, Ketjen Black, Super C45, Black Pearls 2000, Vulcan XC-72, carbon black, a metal-organic framework, porous carbon, carbon spheres, carbon aerogel, carbon nanofiber; single-walled carbon nanotubes, multi-walled carbon nanotubes, carbon nanofibers, carbon nanotube arrays, polypyrrole, polyaniline, poly(3,4-etheylenedioxythiophene), poly(3,4-ethylenedioxythiophene), polystyrene sulfonate, or combinations of two or more thereof. Black Pearls 2000, Super C45, and Ketjen Black are examples of commercially available forms of carbon black. In some embodiments, the conductive carbon matrix includes a mixture of any two or more of graphite, graphene, expanded graphite, reduced graphene oxide, acetylene black, carbon black, metal-organic framework (e.g., a porous, ordered organic-inorganic composite material), porous carbon, carbon spheres, carbon aerogel, single-walled carbon nanotubes, multi-walled carbon nanotubes, carbon nanofibers, carbon nanotube arrays, polypyrrole, and polyaniline. In some embodiments, the conductive carbon matrix includes two forms of carbon black, carbon nanotubes, and/or carbon nanofibers.

For example, the conductive carbon may include a carbon black with a surface area of about 600 m²/g to about 1200 m²/g, a pore volume of about 200 mL/100 g to about 700 mL/100 g, and an intrinsic resistivity of about 0.01 Ω·cm to about 0.1 Ω·cm. The conductive carbon may be a carbon black with a surface area of about 30 m²/g to about 80 m²/g, a particle size of about 80 nm to about 300 nm, and a low Fe impurity level of about 1 ppm or less. The conductive carbon may be carbon black with a bulk density of about 200 kg/m³ to about 300 kg/m³ and an average particle size of about 20 nm to about 50 nm, and a surface area of about 200 m²/g to about 400 m²/g.

For example, the first phase of the conductive carbon may include graphite, graphene, reduced graphene oxide, a first type of carbon black, a metal-organic framework, carbon spheres, carbon aerogel, a first type of carbon nanofibers, a first type of carbon nanotubes, or a first type of carbon nanofibers; and the second phase of the conductive carbon may include a second type of carbon nanotubes, a second type of carbon nanofibers, a second type of carbon black, polypyrrole, polyaniline, poly(3,4-etheylenedioxythiophene), poly(3,4-ethylenedioxythiophene), or polystyrene sulfonate. Where the conductive carbon is present as two different types of carbon black the two types of carbon black may have different surface areas, pore volumes, and/or particle sizes. Where the conductive carbon is present as two different types of carbon nanotubes, the nanotubes may have a different chirality, length, and/or number of walls. Where the conductive carbon is present as two different types of nanofibers, the nanofibers may have different diameters and/or lengths.

As another example, the first phase of the conductive carbon may include graphite, graphene, holey graphene, expanded graphite, reduced graphene oxide, acetylene black, Ketjen Black, Super C45, Black Pearls 2000, Vulcan XC-72, carbon black, a metal-organic framework, porous carbon, carbon spheres, carbon aerogel, or carbon nanofiber; and the second phase of the conductive carbon may include single-walled carbon nanotubes, multi-walled carbon nanotubes, carbon nanofibers, carbon nanotube arrays, polypyrrole, polyaniline, poly(3,4-etheylenedioxythiophene), poly(3,4-ethylenedioxythiophene), or polystyrene sulfonate.

The conductive carbon may be present in the composite electrode material in an amount of about 1% wt. to about 80% wt. of the total weight of the composite electrode material. For example, the conductive carbon may be present at about 5% wt. to about 70% wt., about 10% wt. to about 60% wt., about 15% wt. to about 50% wt., or about 20% wt. to about 30% wt. When the conductive carbon is present as two phases, the ratio of the two phases may be about 0:1 to about 1:0, including about 1:2 to about 2:1, or about 1:1, or any value therebetween.

The conductive carbon may have a high specific surface area (e.g., >100 m²/g). Without being bound by any theory, the high surface area of the conductive carbon may facilitate uniform dispersion of the electroactive material and the solid electrolyte in the composite electrode material. This high surface area may prevent or decrease aggregation of alloying-type material particles during charge/discharge cycling. The alloying-type materials are elements or compounds that may alloy with lithium to form the corresponding alloy during charge/discharge. Alloying may introduce large volume changes, which may result in rapid capacity fading.

The specific surface area of the conductive carbon may be about 100 m²/g to about 2600 m²/g. This includes a specific surface area of about 200 m²/g to about 2600 m²/g, about 400 m²/g to about 2600 m²/g, about 600 m²/g to about 2600 m²/g, about 800 m²/g to about 2600 m²/g, about 1000 m²/g to about 2600 m²/g, about 1200 m²/g to about 2600 m²/g, about 1400 m²/g to about 2600 m²/g, about 1600 m²/g to about 2600 m²/g, about 1800 m²/g to about 2600 m²/g, about 2000 m²/g to about 2600 m²/g, or about 2200 m²/g to about 2600 m²/g. In some embodiments, the high specific surface area is about 100 m²/g, 200 m²/g, 300 m²/g, 400 m²/g, 500 m²/g, 600 m²/g, 700 m²/g, 800 m²/g, 900 m²/g, 1000 m²/g, 1100 m²/g, 1200 m²/g, 1300 m²/g, 1400 m²/g, 1500 m²/g, 1600 m²/g, 1700 m²/g, 1800 m²/g, 1900 m²/g, 2000 m²/g, 2100 m²/g, 2200 m²/g, 2300 m²/g, 2400 m²/g, 2500 m²/g, or 2600 m²/g.

In any embodiment, the composite electrode material may include a binder selected from polybutadiene, poly(acrylic acid), lithiated poly(acrylic acid), sodiated poly(acrylic acid), poly(methyl methacrylate), poly(tert-butyl acrylate), sodium carboxymethylcellulose, sodium alginate, poly(vinyl alcohol), polyvinyl acetate, poly(ethylene imine), carboxymethyl chitosan, glutaraldehyde, β-cyclodextrin polymer, Gum Arabic, PEDOT-PSS, polyacrylic latex, gelatin, polyamido amine, polyvinylidene fluoride, polytetrafluoroethylene, polyethylene, polystyrene, polyethylene oxide, polyimide, styrene butadiene rubber (SBR), polythiophene, polyacetylene, poly(9,9-dioctylfluorene-co-fluorenone), poly(9,9-dioctylfluoene-co-fluorenone-co-methylbenzoic ester), or a blend or copolymer of any two or more such polymers. In some embodiments, the binder is an electrically conductive polymer such as polythiophene, polyacetylene, poly(9,9-dioctylfluorene-co-fluorenone), poly(9,9-dioctylfluoene-co-fluorenone-co-methylbenzoic ester), or a copolymer or blend of any two or more such conductive polymers. The weight percentage of binder in the composite electrode material is about 0% wt. to about 20% wt.

In another aspect, an electrochemical device is provided that includes the composite electrode material disclosed herein. The electrochemical device includes an electrode including the composite electrode material disclosed herein, a counter electrode, and a solid electrolyte membrane separating the two electrodes.

In some embodiments of the electrochemical device, the electrode including the composite electrode material is a cathode and the composite electrode material is a composite cathode material. For example, the composite cathode material may include particles of a cathodic electroactive material including sulfur, selenium, tellurium, metal sulfide, metal selenide, metal fluoride, or a combination of two or more thereof. The metal element in the metal sulfide, metal selenide, and/or metal fluoride may be lithium. The counter electrode in the electrochemical device with the composite cathode may include lithium metal, lithium-indium alloy, graphite, hard carbon, silicon, tin, antimony, lithium, indium, aluminum, silicon, tin, zinc, magnesium, bismuth, gallium, germanium, calcium, or a combination or alloy of two or more thereof.

In some embodiments of the electrochemical device, the electrode including the composite electrode material is an anode and the composite electrode material is a composite anode material. For example, the composite anode material may include particles of an anodic electroactive material including tin, silicon, germanium, phosphorus, antimony, lead, bismuth, graphite, hard carbon, lithium titanate, or a combination of two or more thereof.

The counter electrode in the electrochemical device with the composite anode may include a layered lithium nickel manganese cobalt oxide having a formula of Li_{1+δ}NiₓMn_{y}Co₂O₂ where δ≥0 and x+y+z=1, a layered lithium nickel cobalt aluminum oxide having a formula of LiNiₓCo_{y}Al_{z}O₂ where x+y+z=1, a spinel lithium nickel manganese oxide having a formula of LiNiₓMn₂₋ₓO₄ where 0≤x≤2, LiFePO₄, LiNiPO₄, LiMnₓFe₁₋ₓPO₄, LiCoPO₄, LiCoO₂, LiNiO₂, LiMnO₂, or a combination of any two or more thereof.

The solid electrolyte membrane separating the two electrodes may include an inorganic solid, solid polymer, or composite polymer-inorganic electrolyte. The solid electrolyte membrane may be the same type of material in the composite electrode material or may be a different material. The solid electrolyte membrane may include an oxide (e.g., garnets like Li₇La₃Zr₂O₁₂, perovskites like Li_{0.33}La_{0.55}TiO₃, anti-perovskites like Li₃OX and Li₂(OH)X where X is Cl and/or Br, NASICON-type like Li_{1.5}Al_{0.5}Ti_{1.5}(PO₄)₃), a sulfide (e.g., argyrodite-type LiPS₅X where X is Cl, Br, and/or I; Li₂₊₂ₓZn₁₋ₓGeO₄; Li₁₀GeP₂S₁₂; Li₁₀SnP₂S₁₂; Li₁₀SiP₂S₁₂; Li₂S—P₂S₅; or Li₃PS₄), a halide (e.g., Li₃MX₆, where X is Cl, Br, and/or I; M is Al, Ga, Sc, In, Lu, Tm, Er, Y, Ho, Dy, Tb, Sm, Bi, and/or La), or a combination of two or more thereof. The solid electrolyte membrane may include an ionic conducting compound selected from perovskite, anti-perovskite, NASICON-type oxides, garnet-type oxides, thio-LISCON sulfides, glass sulfides, argyrodite sulfides, halides, polymers, composite materials, or a combination of two or more thereof.

The solid electrolyte membrane may include a coating layer to stabilize the interface with the composite electrode and/or the counter electrode. The coating layer may comprise one or more metal oxides, metal sulfides, metal phosphates, metal halides, metal nitrides, amorphous carbon, polymers, or a combination of two or more thereof.

In some embodiments, the solid electrolyte may have a hybrid multi-layer structure, each layer comprising an ionic conducting compound selecting from perovskite, anti-perovskite, NASICON-type oxides, Garnet-type oxides, thio-LISCON sulfides, glass sulfides, argyrodite sulfides, halides, a polymer, or a combination of two or more thereof.

The electrochemical device may include a current collector disposed on the cathode and/or anode. The current collectors may be any of a wide variety of materials. For example, illustrative current collectors include, but are not limited to, copper, stainless steel, titanium, tantalum, platinum, palladium, gold, silver, iron, aluminum, nickel, rhodium, manganese, vanadium, titanium, tungsten, cobalt, cobalt nickel alloy, highly alloyed ferritic stainless steel containing molybdenum and chromium; or nickel-, chromium-, or molybdenum-containing alloys, or a carbon-coated metal. The current collector may take the form of a foil, mesh, or screen.

The electrochemical device may be a lithium metal battery or a lithium-ion battery that is a primary or secondary battery, and that is operated at room temperature (i.e., about 20° C. to about 30° C.) and/or at elevated temperature (i.e., about 30° C. to about 175° C.). In some embodiments, the electrochemical device is a capacitor. In some embodiments, the electrochemical device is a secondary lithium metal battery. In some embodiments, the electrochemical device is a secondary lithium-ion battery.

In another aspect, a method of making the composite electrode material disclosed herein is provided. The method includes combining the electroactive material, the solid electrolyte material, and the conductive carbon and milling this combination with a sufficient shear, impact, and time to cause partial degradation of the solid electrolyte material, thereby forming the coating made up of solid electrolyte degradation products. Prior to milling, the combination may be physically mixed (e.g., by hand) to form a mixture. Mixing and/or milling may be conducted under inert atmosphere (e.g., under argon gas).

Milling may decrease the average particle sizes in the combination. Prior to milling, the electroactive material particles in the combination may have an average particle size of about 1 μm to about 100 μm, about 5 μm to about 80 μm, about 10 μm to about 70 μm, about 15 μm to about 60 μm, about 20 μm to about 50 μm, about 30 μm to about 40 μm, about 40 μm to about 100 μm, about 50 μm to about 100 μm, about 60 μm to about 100 μm, about 70 μm to about 100 μm, about 80 μm to about 100 μm, or about 90 μm to about 100 μm. After milling, the electroactive material particles may have a particle size of about 10 nm to 5 μm, as described herein. The particles of the electroactive material prior to milling may be crystalline, nanocrystalline, amorphous, or a combination of two or more thereof. In some embodiments, the phase of the electroactive material changes from crystalline to amorphous upon milling.

Prior to milling, the solid electrolyte particles in the combination may have an average particle size of about 1 μm to 100 μm, about 10 μm to about 100 μm, about 20 μm to about 100 μm, about 30 μm to about 100 μm, about 40 μm to about 100 μm, about 50 μm to about 100 μm, about 60 μm to about 100 μm, about 70 μm to about 100 μm, about 80 μm to about 100 μm, or about 90 μm to about 100 μm. After milling, the solid electrolyte particles may have a particle size of about 50 nm to 50 μm, as described herein. The solid electrolyte particles prior to milling may be crystalline, nanocrystalline, amorphous, or a combination of two or more thereof.

Milling may be performed by a planetary mixer (e.g., a planetary centrifugal mixer), a high-shear mixer, a static mixer, a multi-shaft mixer, or a ball mill with sufficient shear, impact, and time to cause partial degradation of the solid electrolyte material.

For example, a planetary mixer may be used for milling at a rotation speed of about 500 rpm (revolutions per minute) to about 5000 rpm. This includes a rotation speed of about 600 rpm to about 5000 rpm, about 700 rpm to about 5000 rpm, about 800 rpm to about 5000 rpm, about 900 rpm to about 5000 rpm, about 1000 rpm to about 5000 rpm, about 1100 rpm to about 5000 rpm, about 1200 rpm to about 5000 rpm, about 1300 rpm to about 5000 rpm, about 1400 rpm to about 5000 rpm, 1500 rpm to about 5000 rpm, about 1600 rpm to about 5000 rpm, about 1700 rpm to about 5000 rpm, about 1800 rpm to about 5000 rpm, about 1900 rpm to about 5000 rpm, about 2000 rpm to about 5000 rom, about 3000 rpm to about 5000 rpm, or about 4000 rpm to about 5000 rpm, including increments therein. In some embodiments, the rotation speed is about 500 rpm, 600 rpm, 700 rpm, 800 rpm, 900 rpm, 1000 rpm, 1100 rpm, 1200 rpm, 1300 rpm, 1400 rpm, 1500 rpm, 1600 rpm, 1700 rpm, 1800 rpm, 1900 rpm, 2000 rpm, 2100 rpm, 2200 rpm, 2300 rpm, 2400 rpm, 2500 rpm.

Milling may be performed for a time period of about 0.5 to about 25 hours. This includes a time period of about 1 hour to about 25 hours, about 2 hours to about 25 hours, about 3 hours to about 25 hours, about 4 hours to about 25 hours, about 5 hours to about 25 hours, about 6 hours to about 25 hours, about 7 hours to about 25 hours, about 8 hours to about 25 hours, about 9 hours to about 25 hours, about 10 hours to about 25 hours, about 11 hours to about 25 hours, about 12 hours to about 25 hours, about 15 hours to about 25 hours, or about 20 hours to about 25 hours. In some embodiments, the milling is performed for a time period of about 1 hour to 10 hours. This includes a time period of about 2 hours to about 10 hours, about 3 hours to about 10 hours, about 4 hours to about 10 hours, about 5 hours to about 10 hours, about 6 hours to about 10 hours, about 7 hours to about 10 hours, about 8 hours to about 10 hours, or about 9 hours to about 10 hours. The time period may be about 1 hour, about 2 hours, about 3 hours, about 4 hours, about 5 hours, about 6 hours, about 7 hours, about 8 hours, about 9 hours, or about 10 hours. As mixing speed increases, mixing time may decrease. Milling may be conducted in a variety of containers. The container may be sealed under inert atmosphere (e.g., argon gas) prior to milling.

In another aspect, a method of preparing an electrochemical device including the composite electrode material is provided. The method includes forming a pellet of solid electrolyte to serve as the solid electrolyte membrane between the two electrodes. Forming the pellet of solid electrolyte membrane may include compressing a powder of the solid electrolyte at a pressure sufficient to form a pellet. For example, compression may be performed at a pressure of about 50 MPa to about 500 MPa, about 60 MPa to about 400 MPa, about 60 MPa to about 300 MPa, about 60 MPa to about 150 MPa, or about 100 MPa. The method may also include compressing the composite solid electrode to form a pellet of solid electrode. Forming the composite solid electrode may be performed by applying the powdered composite solid electrode, formed as described herein, onto the solid electrolyte membrane pellet and then compressing. The composite solid electrode may be compressed at a pressure of about 100 MPa to about 1000 MPa, about 200 MPa to about 900 MPa, about 300 MPa to about 800 MPa, about 400 MPa to about 700 MPa, or about 500 MPa. In some embodiments, the counter electrode includes compressed powders and may be formed in the same way. In some embodiments, the counter electrode is a metal foil that may be applied to a side of the solid electrolyte opposite the composite electrode. The assembled stack of two electrodes and solid electrolyte therebetween may be pressed at about 50 MPa to about 600 MPa, about 100 MPa to about 500 MPa, about 200 MPa to about 400 MPa, about 300 MPa to about 400 MPa, or about 350 MPa. The assembled stack may be disposed in a housing case and tightened to about 1 N·m to about 10 N·m (e.g., 4 N·m) of pressure for cell testing.

The present invention, thus generally described, will be understood more readily by reference to the following examples, which are provided by way of illustration and are not intended to be limiting of the present invention.

### Examples

Example 1. Preparation of a composite electrode material including a sulfur electroactive material coated with a multilayer coating, argyrodite-type solid electrolyte coated with the multilayer coating, and conductive carbon. Sulfur, Li₂S—P₂S₅—LiCl argyrodite-type solid electrolyte, Ketjen Black conductive carbon, and super C45 conductive carbon were manually mixed in a weight ratio of 22.75/50/12.25/15 and then mixed in a planetary centrifugal mixer at 2000 rpm for 300 minutes.

Example 2. Preparation of a composite electrode material including a sulfur electroactive material coated with a multilayer coating, argyrodite-type solid electrolyte coated with the multilayer coating, and conductive carbon. Sulfur, Li₂S—P₂S₅—LiCl argyrodite-type solid electrolyte, Ketjen Black conductive carbon, and super C45 conductive carbon were manually mixed in weight ratio of 22.75/50/12.25/15 in an argon-filled glove box and then mixed in a planetary centrifugal mixer at 2000 rpm for 60 minutes.

Example 3. Preparation of a composite electrode material including a sulfur electroactive material coated with a multilayer coating, argyrodite-type solid electrolyte coated with the multilayer coating, and conductive carbon. Sulfur, Li₂S—P₂S₅—LiCl argyrodite-type solid electrolyte, Ketjenblack conductive carbon, and super C45 conductive carbon were manually mixed in weight ratio of 22.75/50/12.25/15 in an argon-filled glove box and then mixed in a planetary centrifugal mixer at 2000 rpm for 600 minutes.

Example 4. Preparation of a composite electrode material including a sulfur electroactive material coated with a multilayer coating, argyrodite-type solid electrolyte coated with the multilayer coating, and super C45 conductive carbon. Sulfur, Li₂S—P₂S₅—LiCl argyrodite-type solid electrolyte, and super C45 conductive carbon were manually mixed in weight ratio of 22.75/50/37.25 in an argon-filled glove box and then mixed in a planetary centrifugal mixer at 2000 rpm for 300 minutes.

Example 5. Preparation of a composite electrode material including a sulfur electroactive material coated with a multilayer coating, argyrodite-type solid electrolyte coated with the multilayer coating, and Ketjenblack conductive carbon. Sulfur, Li₂S—P₂S₅—LiCl argyrodite-type solid electrolyte, and Ketjenblack conductive carbon were manually mixed in weight ratio of 22.75/50/37.25 in an argon-filled glove box and then mixed in a planetary centrifugal mixer at 2000 rpm for 300 minutes.

Example 6. Preparation of a composite electrode material including a sulfur electroactive material coated with a multilayer coating, Li₂S—P₂S₅—LiCl—LiI argyrodite-type solid electrolyte coated with the multilayer coating, and conductive carbon. Sulfur, Li₂S—P₂S₅—LiCl—LiI argyrodite-type solid electrolyte, Ketjenblack conductive carbon, and super C45 conductive carbon were manually mixed in weight ratio of 22.75/50/12.25/15 in an argon-filled glove box and then mixed in a planetary centrifugal mixer at 2000 rpm for 300 minutes.

Example 7. Preparation of a composite electrode material including a sulfur electroactive material coated with a multilayer coating, Li₂S—P₂S₅—LiCl—LiBr argyrodite-type solid electrolyte coated with the multilayer coating, and conductive carbon. Sulfur, Li₂S—P₂S₅—LiCl—LiBr argyrodite-type solid electrolyte, Ketjenblack conductive carbon, and super C45 conductive carbon were manually mixed in weight ratio of 22.75/50/12.25/15 in an argon-filled glove box and then mixed in a planetary centrifugal mixer at 2000 rpm for 300 minutes.

Example 8. Preparation of a composite electrode material including a sulfur electroactive material coated with a multilayer coating, Li₂S—P₂S₅—LiBr argyrodite-type solid electrolyte coated with the multilayer coating, and conductive carbon. Sulfur, Li₂S—P₂S₅—LiBr argyrodite-type solid electrolyte, Ketjenblack conductive carbon, and super C45 conductive carbon were manually mixed in weight ratio of 22.75/50/12.25/15 in an argon-filled glove box and then mixed in a planetary centrifugal mixer at 2000 rpm for 300 minutes.

Example 9. Preparation of a composite electrode material including a sulfur electroactive material coated with a multilayer coating, Li₂S—P₂S₅ solid electrolyte coated with the multilayer coating, and conductive carbon. Sulfur, Li₂S—P₂S₅ solid electrolyte, Ketjenblack conductive carbon, and super C45 conductive carbon were manually mixed in weight ratio of 22.75/50/12.25/15 in an argon-filled glove box and then mixed in a planetary centrifugal mixer at 2000 rpm for 300 minutes.

Example 10. Preparation of a composite electrode material including a selenium electroactive material coated with a multilayer coating, an argyrodite-type solid electrolyte coated with the multilayer coating, and conductive carbon. Selenium electroactive material, Li₂S—P₂S₅—LiCl argyrodite-type solid electrolyte, Ketjenblack conductive carbon, and super C45 conductive carbon were manually mixed in weight ratio of 22.75/50/12.25/15 in an argon-filled glove box and then mixed in a planetary centrifugal mixer at 2000 rpm for 300 minutes.

Example 11. Preparation of a composite electrode material including a selenium electroactive material coated with a multilayer coating, an Li₂S—P₂S₅—LiBr argyrodite-type solid electrolyte coated with the multilayer coating, and conductive carbon. Selenium electroactive material, Li₂S—P₂S₅—LiBr argyrodite-type solid electrolyte, Ketjenblack conductive carbon, and super C45 conductive carbon were manually mixed in a weight ratio of 22.75/50/12.25/15 an argon-filled glove box and then mixed in a planetary centrifugal mixer at 2000 rpm for 300 minutes.

Example 12. Preparation of a composite electrode material included SeS₂ electroactive material coated with a multilayer coating, an Li₂S—P₂S₅—LiCl argyrodite-type solid electrolyte coated with the multilayer coating, and conductive carbon. SeS₂ electroactive material, Li₂S—P₂S₅—LiCl argyrodite-type solid electrolyte, Ketjenblack conductive carbon, and super C45 conductive carbon were manually mixed in a weight ratio of 22.75/50/12.25/15 in an argon-filled glove box and then mixed in a planetary centrifugal mixer at 2000 rpm for 300 minutes.

Example 13. Preparation of a composite electrode material included tin electroactive material coated with a multilayer coating, an Li₂S—P₂S₅—LiCl argyrodite-type solid electrolyte coated with the multilayer coating, and conductive carbon. Tin electroactive material, Li₂S—P₂S₅—LiCl argyrodite-type solid electrolyte, Ketjenblack conductive carbon, and super C45 conductive carbon were manually mixed in a weight ratio of 22.75/50/12.25/15 in an argon-filled glove box and then mixed in a planetary centrifugal mixer at 2000 rpm for 300 minutes.

Example 14. The crystal structures of composite electrode materials according to Examples 1-13 were examined by X-ray diffraction (XRD), which can detect the long-range order of crystalline structures.

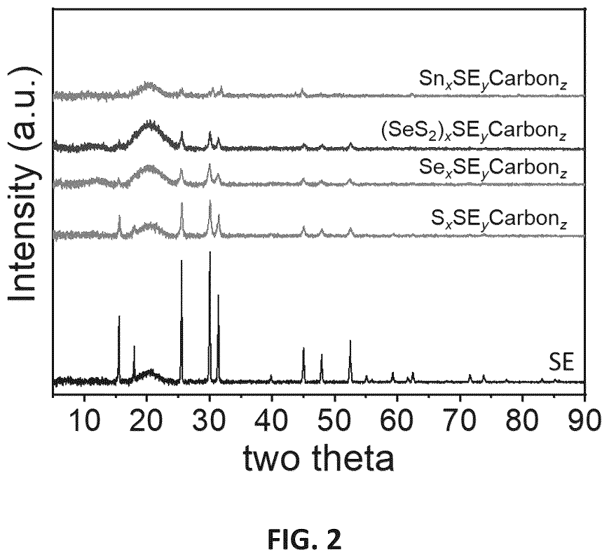

FIG. 2 is a graph of X-ray diffraction patterns of different composite electrode materials with multilayer coatings. The XRD results showed that the composite electrode material according to Example 1, Example 10, Example 12, and Example 13 all appeared amorphous due to a lack of sharp XRD peaks from electroactive materials. These XRD results did show XRD peaks resulting from the Li₂S—P₂S₅—LiCl solid electrolyte.

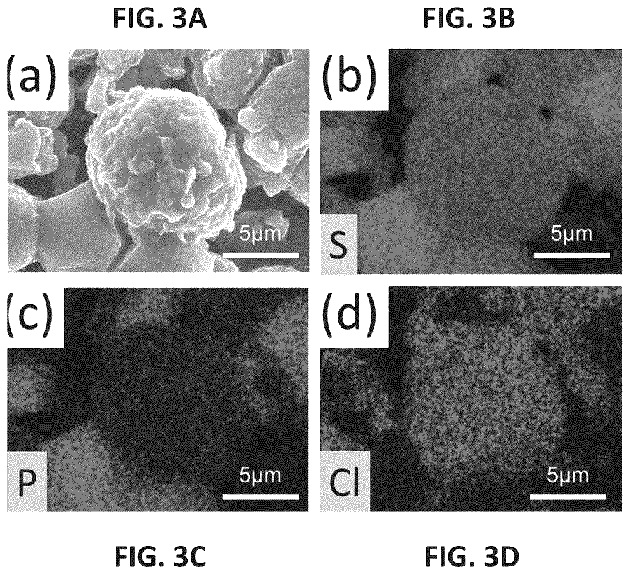

Example 15. The microstructure and morphology of the electrode composite material was investigated with scanning electron microscopy (SEM). The microstructure and morphology of the electrode composite material of Example 1 was investigated. FIG. 3A is a scanning electron microscopy (SEM) image of an electrode composite material including sulfur electroactive material coated with a multilayer coating, argyrodite solid electrolyte coated with the multilayer coating, and carbon. FIG. 3B is sulfur elemental mapping of the image in FIG. 3A. FIG. 3C is phosphorus elemental mapping of the image in FIG. 3A. FIG. 3D is chlorine elemental mapping of the image in FIG. 3A. As shown, no obvious aggregation of sulfur was observed (FIG. 3A) indicating uniform mixing of sulfur in the composite. The elemental mapping of the SEM image showed that sulfur (FIG. 3B) and phosphorus (FIG. 3C) were homogeneously distributed throughout the solid electrolyte in FIG. 3A, while the chlorine (FIG. 3D) of the solid electrolyte was located at the interface between the solid electrolyte and elemental sulfur, indicating formation of new interphase between the solid electrolyte and the elemental sulfur.

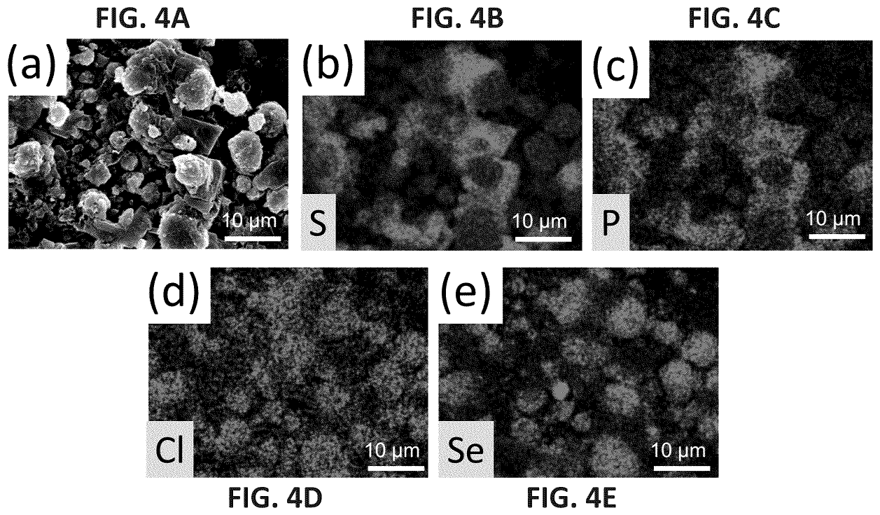

Example 16. The microstructure and morphology of the composite electrode of Example 10 was investigated with SEM. FIG. 4A is an SEM image of an electrode composite material including selenium coated with a multilayer coating, argyrodite solid electrolyte coated with the multilayer coating, and carbon. FIG. 4B is sulfur elemental mapping of the image in FIG. 4A. FIG. 4C is phosphorus elemental mapping of the image in FIG. 4A. FIG. 4D is chlorine elemental mapping of the image in FIG. 4A. FIG. 4E is selenium elemental mapping of the image in FIG. 4A. As shown, no obvious aggregation of selenium was observed (FIG. 4A) indicating a uniform mixing of selenium in the composite. The elemental mapping of SEM image shows that sulfur (FIG. 4B) and phosphorus (FIG. 4C) were homogeneously distributed throughout the solid electrolyte in FIG. 4A, while the chlorine (FIG. 4D) of the solid electrolyte located at the interface between the solid electrolyte and elemental selenium and within the elemental selenium (FIG. 4E), indicating formation of a new interphase.

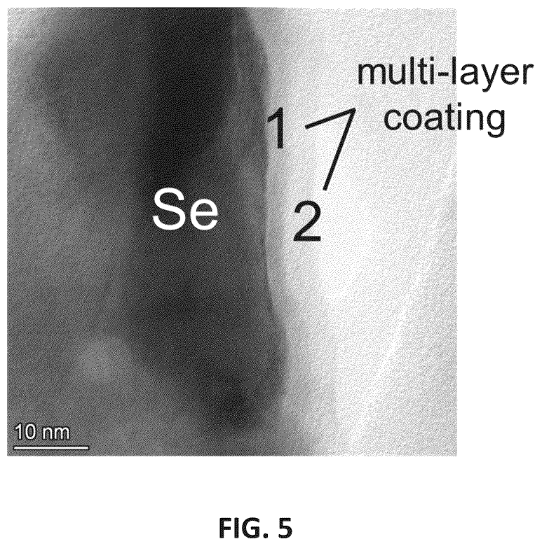

Example 17. The microstructure and morphology of the composite electrode including selenium coated with a multilayer coating, argyrodite solid electrolyte coated with the multilayer coating, and carbon of Example 10 was investigated with transmission electron microscopy (TEM). FIG. 5 is a bright-field TEM image of the electrode composite material of Example 10. In the bright-field TEM image, the elements with heavy chalcogen value appear darker due to the contrast between heavier chalcogen element (e.g., selenium) and lighter elements (e.g., oxygen, sulfur, nitrogen, phosphorus, fluorine, chlorine, bromine, and iodine). As shown, a multi-layer coating was observed on the surface of selenium particles.

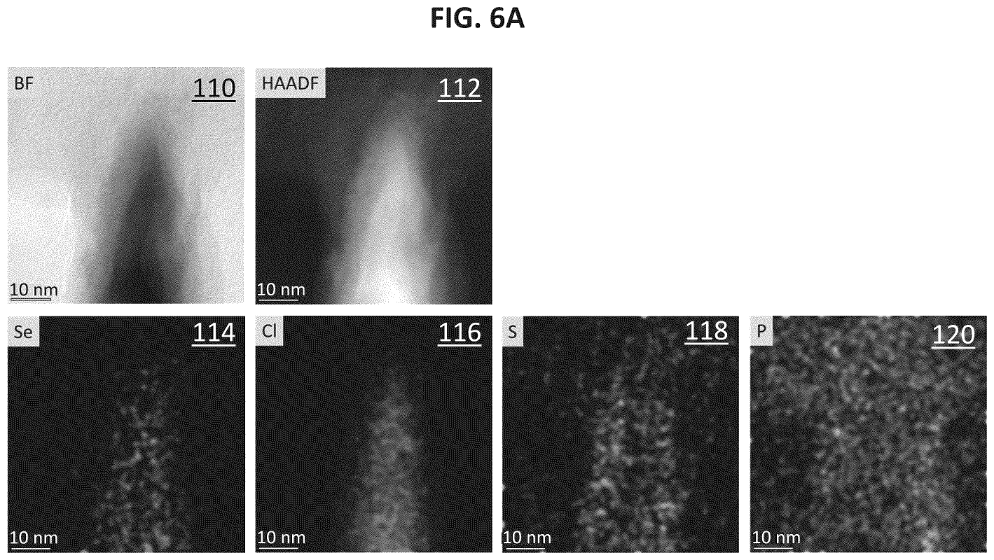

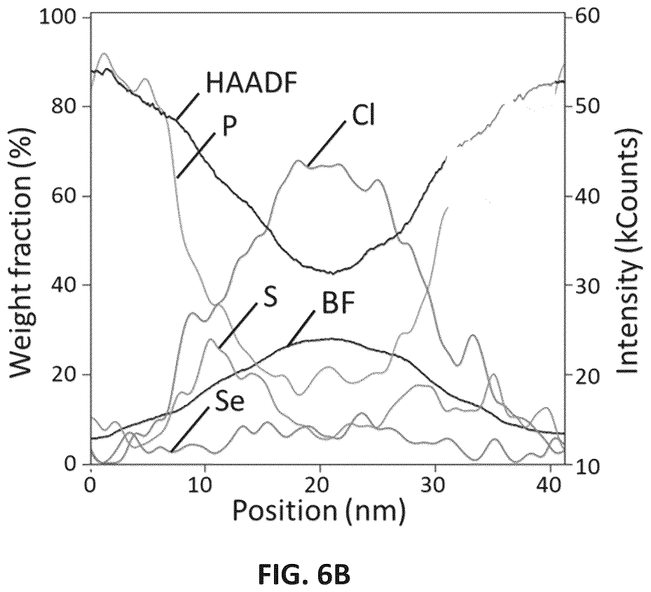

FIG. 6A shows another bright-field TEM image 110, a high-angle annular dark field-transmission electron microscopy (HAADF-TEM) image 112, and elemental EDS mapping 114, 116, 118, and 120 showing selenium, chlorine, sulfur, and phosphorus mapping, respectively, of the electrode composite material of Example 10. In the dark-field TEM image 112, the elements with heavier chalcogen value appear brighter due to the contrast between heavier chalcogen element (e.g. Se) and light chalcogen element. Cl mapping overlapped with Se mapping at the interface between the solid electrolyte and elemental selenium particles, while S mapping and P mapping did not overlap with Se mapping but dispersed wider around Se mapping. FIG. 6B is a graph of the elemental EDS mapping across a cross-section of the TEM image in FIG. 6A. It can be clearly seen that the coating layer having chlorine was deposited on the Se active materials, a coating layer containing sulfur was deposited on the chlorine-containing coating layer, and a coating layer containing phosphorus was deposited on the sulfur-containing coating layer.

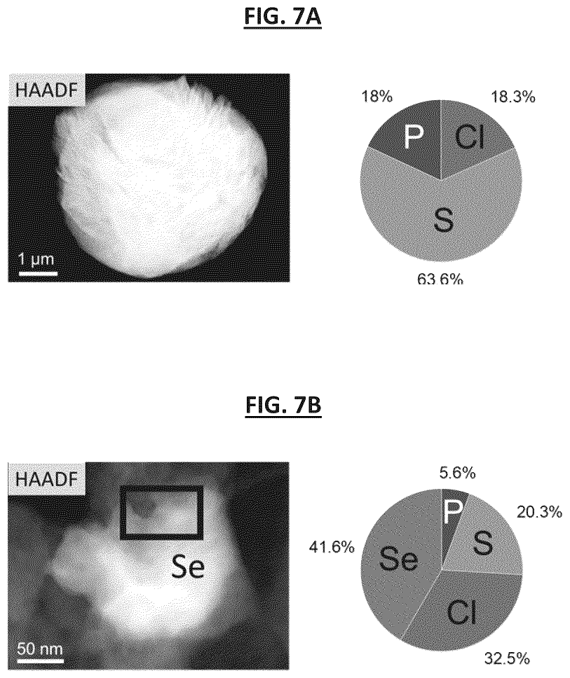

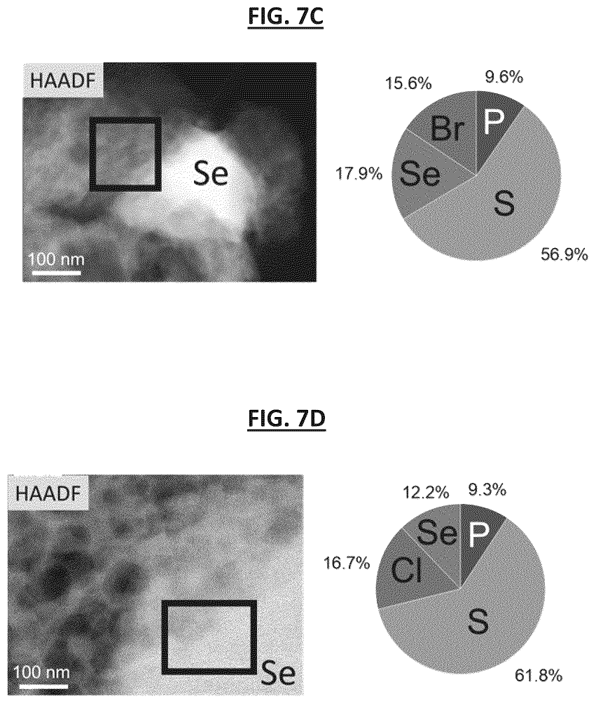

FIG. 7A is a high-angle annular diffraction (HAADF) TEM image and elemental mapping of Li₂S—P₂S₅—LiCl solid electrolyte. FIG. 7B is a HAADF TEM image and elemental mapping of an electrode composite material including selenium electroactive material coated with a multilayer coating, Li₂S—P₂S₅—LiCl solid electrolyte coated with the multilayer coating, Ketjen Black conductive carbon, and super C45 conductive carbon according to Example 10. FIG. 7C is a HAADF TEM image and elemental mapping of an electrode composite material including selenium electroactive material coated with a multilayer coating, Li₂S—P₂S₅—LiBr solid electrolyte coated with the multilayer coating, Ketjen Black conductive carbon, and super C45 conductive carbon according to Example 11. FIG. 7D is a HAADF TEM image and elemental mapping of an electrode composite material including SeS₂ electroactive material coated with a multilayer coating, Li₂S—P₂S₅—LiCl solid electrolyte coated with the multilayer coating, Ketjen Black conductive carbon, and super C45 conductive carbon according to Example 12.

For the electrode composites of Examples 10, 11, and 12 in FIGS. 7B-7D, the designated rectangular area was measured for EDS elemental analysis. The atomic ratio of S, P, Se, and halide elements of the electrode composites of Example 10, 11, and 12 was compared to EDS spectra of Li₂S—P₂S₅—LiCl solid electrolyte. While Li₂S—P₂S₅—LiCl showed atomic ratio of Cl:P around 1:1 (FIG. 7A), the atomic ratio of halogen:P in the electrode composite of Example 10 (FIG. 7B), electrode composite of Example 11 (FIG. 7C), and the electrode composite of Example 11 (FIG. 7D) measured to be 5.8:1, 1.6:1, and 1.8:1, respectively, which are all higher than 1:1. The higher halogen:P ratios indicated increased amount of halogen, namely Cl or Br, at the interface between the electroactive material, namely SeS₂ or Se, and the solid electrolyte, suggesting the formation of metal halide coating layer on the electroactive material.

Example 18. A battery incorporating the electrode composite of Example 1 was assembled. Li₂S—P₂S₅—LiCl was pelletized at 100 MPa to serve as a solid electrolyte separating layer between the anode and cathode. The electrode composite of Example 1 was applied onto the SE pellet and compressed at 500 MPa to serve as the cathode. The areal mass loading of sulfur was 4 mg/cm². Lithium and indium foils were used as anodes (also referred to herein as counter electrodes). The foils were placed on the opposite side of the cathode-solid electrolyte pellet, and the entire cell was pressed at 350 MPa. After pressing, the cell was positioned in a housing case and tightened to 4 N m of pressure for cell testing. Cell assembly was conducted in an argon-filled glove box.

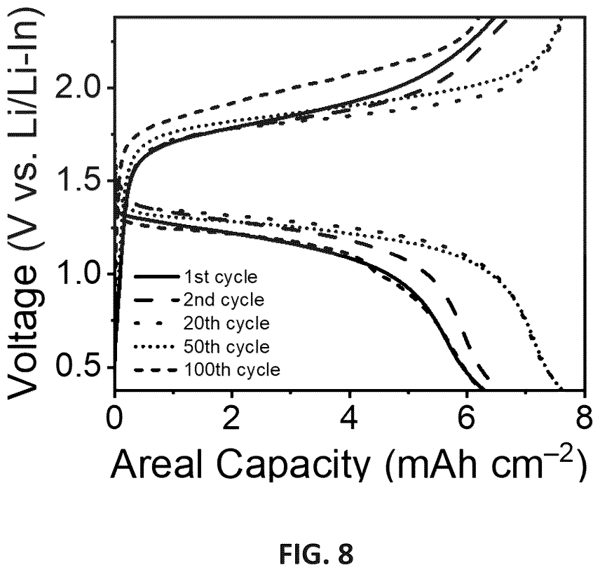

Example 19. Electrochemical properties of the battery of Example 18 were characterized. FIG. 8 is a graph of charge/discharge curves for the battery of Example 18 cycled at a rate of C/10 (1C=1675 mA g⁻¹). With regard to the discharge profiles, the general lithiation curves included a sloping region from 1.6 V to 1 V (vs. Li/Li—In), followed by an inclined plateau from about 1 V to 0.6 V (vs. Li/Li—In), and another sloping region from about 0.6 V to 0.4 V (vs. Li/Li—In). With regard to the charge profile, the de-lithiation curves included a sloping region from 0.4 V to 1.6V (vs. Li/Li—In), an inclined plateau from 1.6 V to 2 V and another sloping region up to 2.4 V (vs. Li/Li—In).

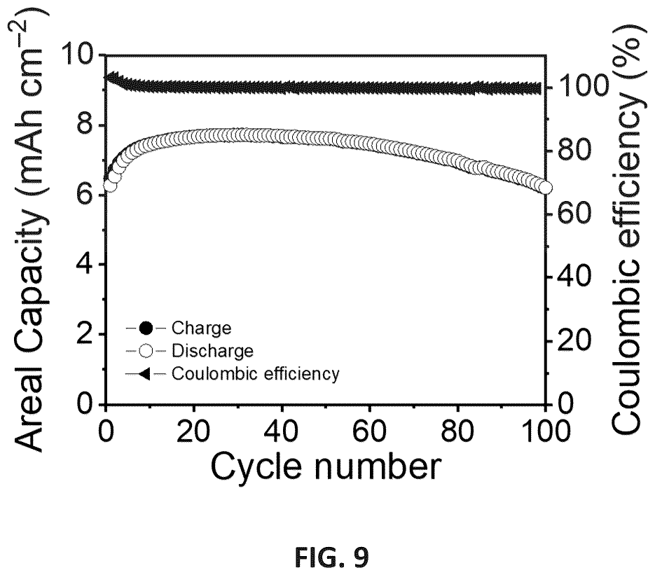

FIG. 9 is a graph of cycling performance of the electrode composite according to Example 1 with 4 mg/cm² sulfur loading cycled at a rate of C/10. The initial discharge and charge capacity were determined to be 6.28 mAh/cm² and 6.47 mAh/cm², respectively, resulting in a high utilization of 96.6%, compared to the theoretical capacity of sulfur (1675 mAh/g). Upon continuous charge/discharge at C/10, the composite cathode maintained its capacity for 100 cycles, indicating excellent cycle and capacity stability. The discharge capacity after 100 cycles was measured at 6.21 mAh/cm², corresponding to capacity retention as high as about 98.9%. The superior cycle stability of the composite cathode indicated its highly reversible lithiation/de-lithiation during charge/discharge and suggesting that large volume changes were suppressed. Unless otherwise specified, the capacities described herein are calculated based on the mass loading of the active materials in the composite electrodes. The composite cathode maintained a high overall capacity of about 6 mAh/cm² for 100 cycles.

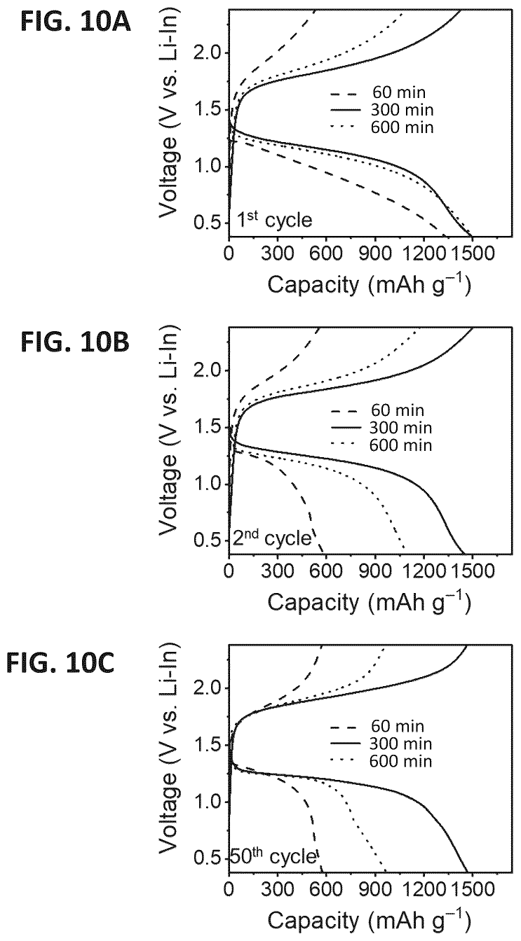

Example 20. Electrochemical properties of batteries that included the electrode materials of Example 2 and Example 3, having the same composition as Example 1, but milled for either 60 minutes and 600 minutes, respectively, were investigated. The batteries were assembled in the same way as in Example 18. The charge/discharge profile of the composite cathodes of Examples 1, 2, and 3 were cycled at C/10 (1C=1675 mA g⁻¹). FIG. 10A is a graph of first charge/discharge curves for the composite electrodes according to Examples 1-3 with 4 mg/cm² sulfur loading. FIG. 10B is a graph of the second charge/discharge curves for the electrodes in FIG. 10A. FIG. 10C is a graph of the fiftieth charge/discharge curves for the electrodes in FIG. 10A. In the charge/discharge profiles, the mean voltage difference of lithiation/de-delithiation curves was lower at 5 hours, followed by 600 minutes and 60 minutes.

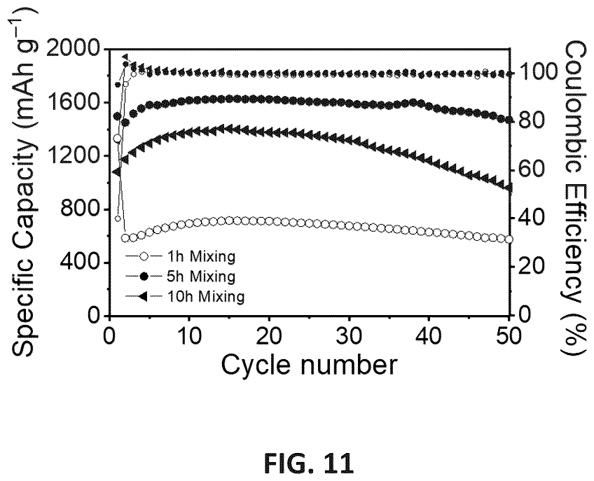

FIG. 11 is a graph of cycling performance of the electrodes in FIG. 10A. The initial discharge capacity of the composite electrode milled for 60 minutes, 300 minutes, and 600 minutes were determined to be 1333 mAh/g, 1498 mAh/g, and 1082 mAh/g, respectively, indicating that short milling time was insufficient to achieve homogeneous coating at the interface while long milling time deteriorated Li ion conduction throughout the composite due to the severe degradation of the solid electrolyte. The reversible capacity of the composite electrode milled for 60 minutes, 300 minutes, and 600 minutes after 50 cycles were measured at 575 mAh/g, 1471 mAh/g, 963 mAh/g, respectively, corresponding to capacity retention of 43%, 98%, and 89%.

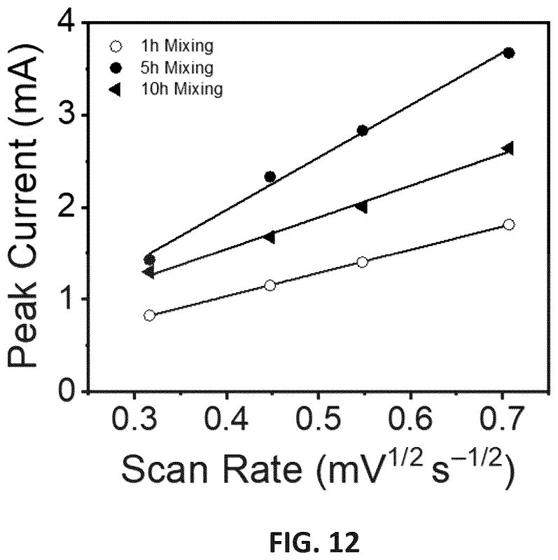

FIG. 12 is a graph of the linear fits of peak current at different scan rates of performance of the electrodes in FIGS. 10A-10C. Peak current was dependent on the scan rates of the composite cathode milled for 60 minutes, 300 minutes, and 600 minutes. Peak currents were extracted from the cyclic voltammetry tests of examples conducted at scan rates of 0.1 mV/s, 0.2 mV/s, 0.3 mV/s, and 0.5 mV/s where the slope of scan rates versus peak current was proportional to the lithium-ion diffusion coefficient within the composite. The composite electrode milled for 300 minutes achieved higher lithium-ion diffusion, indicating the multi-layer coating derived from the decomposition of the solid electrolyte can facilitate the ionic transport without compromising the structural integrity of the solid electrolytes.

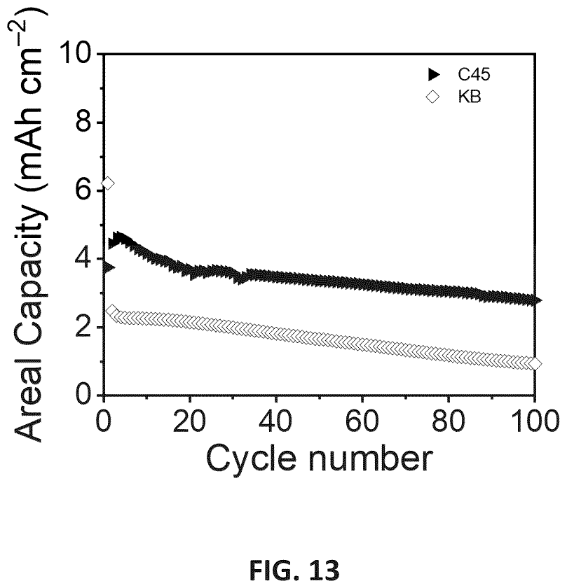

Example 21. Electrochemical properties of a battery that includes composite electrodes according to Examples 4 and 5, prepared in the same fashion as in Example 18. FIG. 13 is a graph of the cycle performance of composite electrodes of Examples 4 and 5 at C/10 (1C=1675 mA g⁻¹) and with 4 mg/cm² sulfur loading. As shown, the composite electrode with super C45 and composite electrode with Ketjen black delivered reversible capacities of 0.9 mAh/cm² and 2.8 mAh/cm², respectively, after 100 cycles. The capacity of these batteries was lower compared to the dual-component conductive carbon in Example 1, indicating dual-component conductive carbon may facilitate electronic transport and suppress large volume changes.

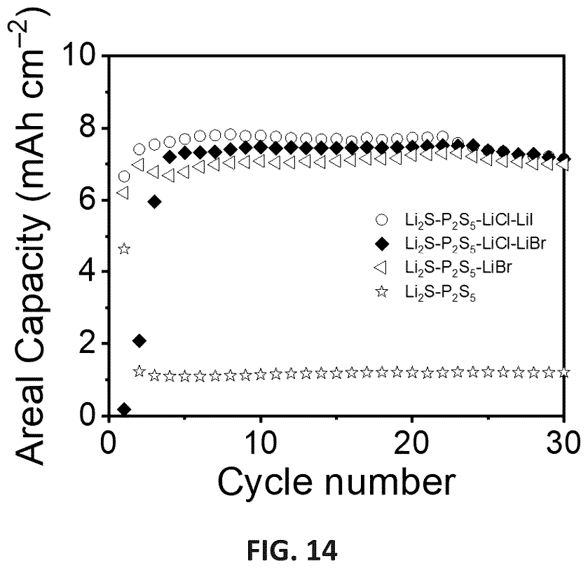

Example 22. Electrochemical properties of a battery that includes the composite cathode materials of Examples 6-9 prepared in the same fashion as in Example 18. FIG. 14 is a graph of the cycle performance of composite electrodes of Examples 6, 7, 8, and 9 at C/10 (1C=1675 mA g⁻¹) with 4 mg/cm² sulfur loading. For the cycle stability, the composite electrode with Li₂S—P₂S₅—LiCl—LiI, Li₂S—P₂S₅—LiCl—LiBr, Li₂S—P₂S₅—LiBr delivered stable capacity of 7 mAh/cm² over 30 cycles while the composite electrode with Li₂S—P₂S₅ delivered only 1.2 mAh/cm². The reversible capacities of the composite electrodes with Li₂S—P₂S₅—LiCl—LiI, Li₂S—P₂S₅—LiCl—LiBr, or Li₂S—P₂S₅—LiBr indicated higher sulfur utilization during charge/discharge than the composite electrode with Li₂S—P₂S₅. Without being bound by any theory, these results indicated that the nanocrystalline lithium halide interphase formed between sulfur and solid electrolyte may have enhanced the ionic conduction.

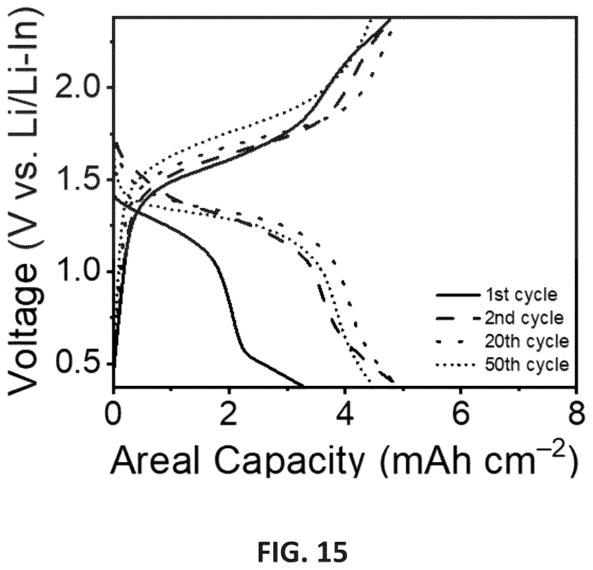

Example 23. Electrochemical properties of a battery that includes the composite electrode material of Example 10 was prepared in the same fashion as in Example 18. FIG. 15 is a graph of charge/discharge curves of the composite electrode of Example 10 at C/10 (1C=675 mA g⁻¹) with 4 mg/cm² selenium loading. In the discharge profile, the general lithiation curves consisted of a sloping region from 1.6 V to 1 V (vs. Li/Li—In), corresponding to the lithiation between Li and Se to form Li₂Se. With regard to the charge profiles, the de-lithiation curves included a sloping region centered at 1.65 V and corresponding to the delithiation of Li₂Se to Se.

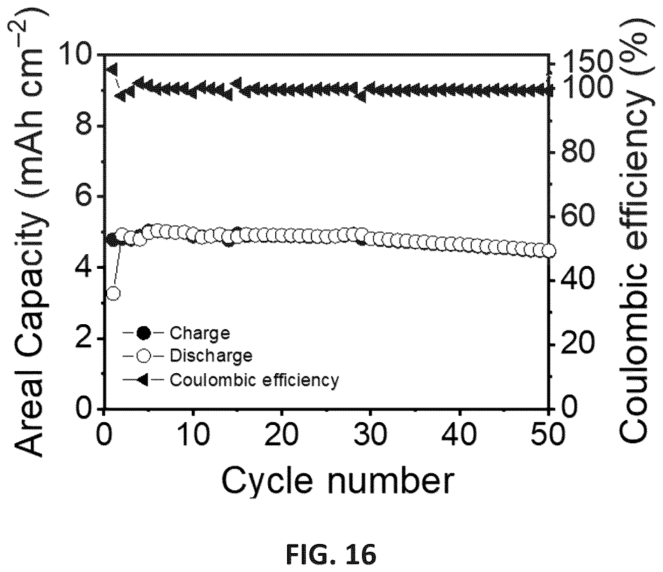

FIG. 16 is a graph of the cycle performance of the electrode in FIG. 15. As shown, the composite electrodes delivered a reversible capacity of about 4.8 mAh/cm² (about 178% of the theoretical capacity of Se), indicating additional reversible capacity from the solid electrolyte itself. The results also showed stable capacities over 50 cycles, indicating excellent cyclability. The discharge capacity after 50 cycles was determined to be 4.5 mAh/cm², corresponding to a capacity retention as high as 93.0%. The cycle stability of the composite electrode of Example 10 indicated reversible lithiation/de-lithiation during charge/discharge. This, too, indicated that large volume changes were suppressed in the composite electrode.

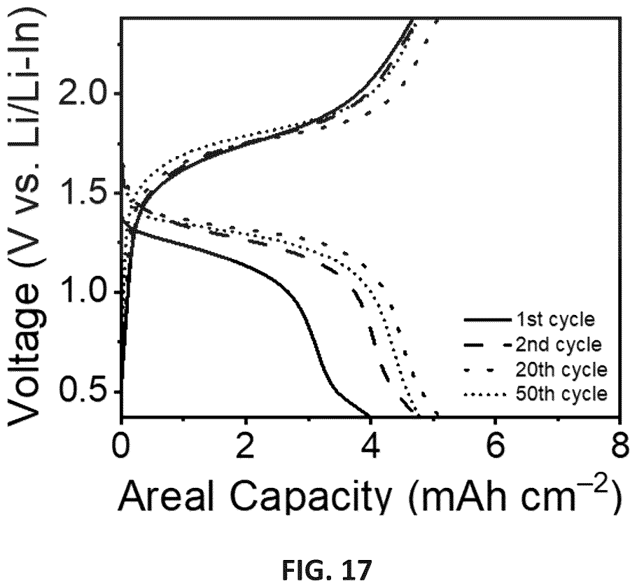

Example 24. Electrochemical properties of a battery that included the composite electrode material according to Example 12 was prepared in the same fashion as in Example 18. FIG. 17 is a graph of charge/discharge curves of the battery with the electrode composite of Example 12, with 4 mg/cm² SeS₂ loading cycled at a rate of C/10 (1C=1342 mA g⁻¹). The initial discharge and charge capacity were determined to be 4.0 mAh/cm² and 4.7 mAh/cm², respectively.

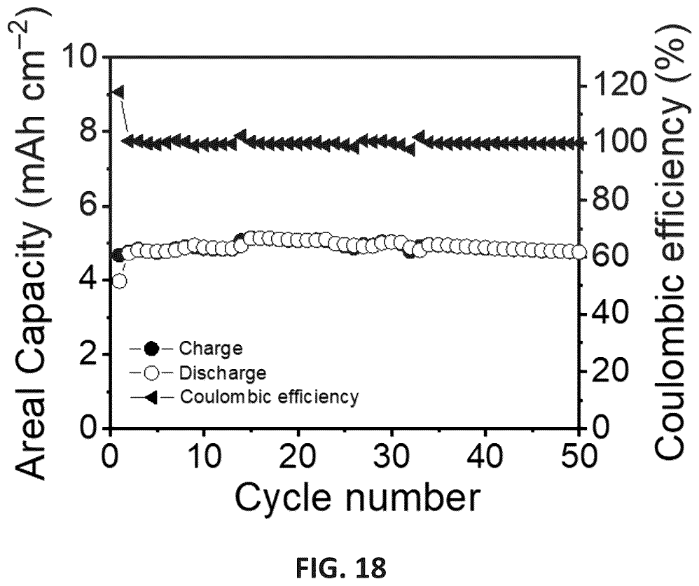

FIG. 18 is a graph of the cycle performance of the electrode in FIG. 17. The battery delivered a stable capacity of about 4.8 mAh/cm² over 50 cycles. The discharge capacity after 60 cycles was measured at 4.77 mAh/cm², corresponding to a capacity retention as high as 99.2% compared to the third cycle after activation of SeS₂. Due to the higher electronic conductivity of Se than S, as well as the better ionic diffusion of nanocrystalline Se than amorphous S, the composite electrode of Example 12 demonstrated very good cycle stability.

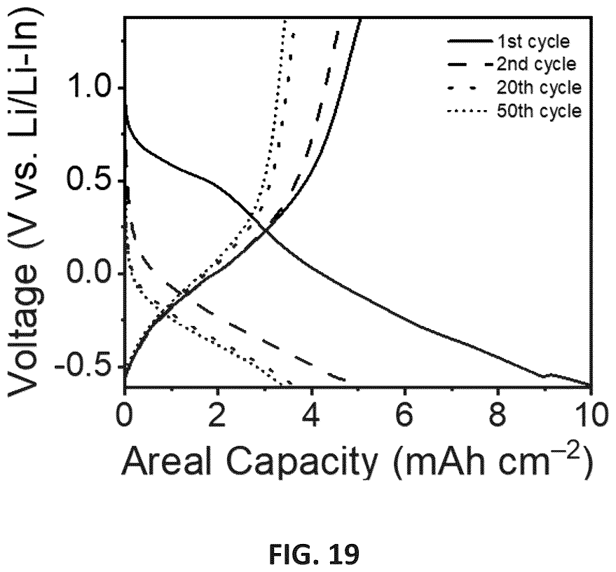

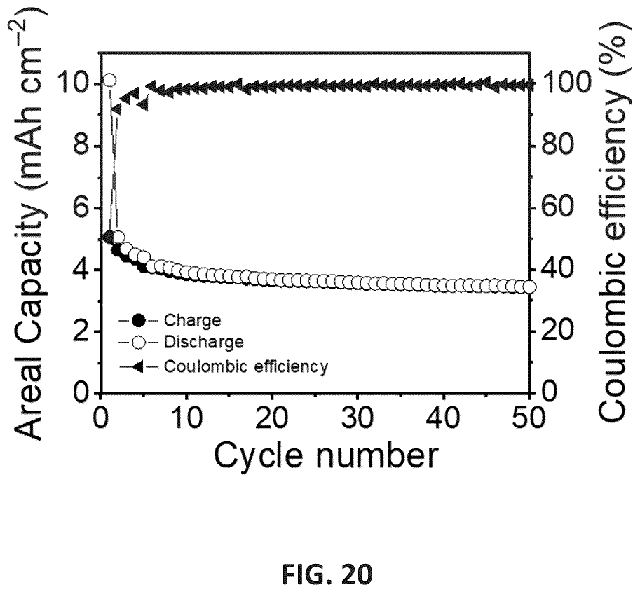

Example 25. Electrochemical properties of a half-cell that included the composite electrode material according to Example 13 was prepared in the same fashion as in Example 18, except that the composite electrode according to Example 13 functioned as the anode. A lithium metal counter electrode was used. FIG. 19 is a graph of charge/discharge curves of the composite electrode material according to Example 13 with 4 mg/cm² tin loading cycled at a rate of C/10 (1C=993 mA g⁻¹). In the discharge profile, the lithiation curves included a sloping region from 0.5 V to −0.61 V (vs. Li/Li—In), corresponding to the lithiation between Li and Sn. With regard to the charge profiles, the de-lithiation curves included a sloping region centered at 0.2 V, corresponding to the delithiation. FIG. 20 is a graph of cycle performance of the electrode in FIG. 19. As shown, the composite electrode material according to Example 13 delivered a reversible capacity of about 5.1 mAh/cm² at the first cycle and maintained 3.4 mAh/cm² after 50 cycles, confirming this approach is also applicable to the anode.

Comparative Example 1. Preparation of an electrode material including a sulfur electroactive material, Li₂S—P₂S₅—LiCl argyrodite-type solid electrolyte, Ketjen black conductive carbon, super C45 conductive carbon. Sulfur, Li₂S—P₂S₅—LiCl, Ketjen Black, and super C45 were manually mixed in weight ratio of 22.75/50/12.25/15 in an argon-filled glove box and then transferred to a planetary mixer and milled at 400 rpm for 300 minutes.

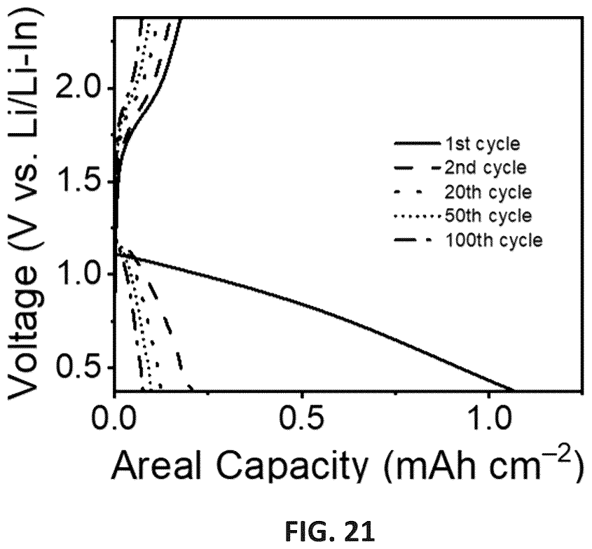

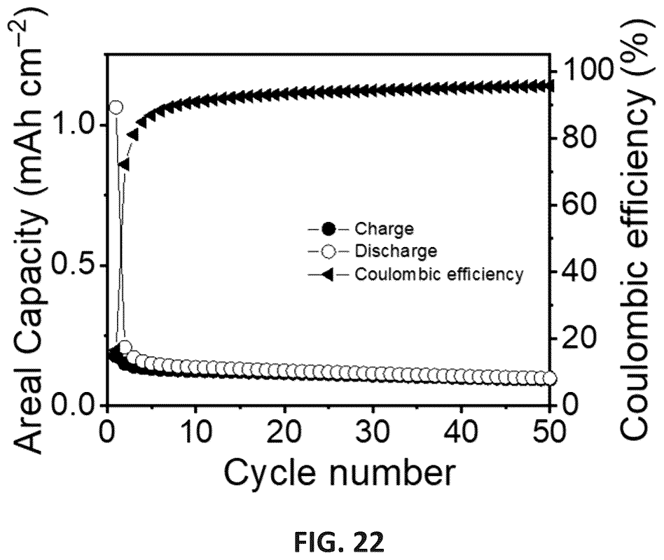

Comparative Example 2. Electrochemical properties of a battery that included composite electrode material of Comparative Example 1 was prepared in the same fashion as in Example 18. The charge/discharge profile of the battery at C/10 (1C=1675 mA g⁻¹) is shown in FIG. 21. The discharge curves showed a continuously decreasing slope without a distinct plateau. The cycle performance of the composite electrode prepared by milling at 400 rpm is shown in FIG. 22. In the charge/discharge profiles, the first and 100th discharge capacity showed 1 mAh/cm² and 0.07 mAh/cm², which is far below the capacity of the composite electrode material according to Example 1. The composite electrode materials of Example 1 and Comparative Example 1 included the same starting composition and preparation method except for the milling speed, indicating that the composite electrode material prepared with high-speed milling at 2000 rpm had higher sulfur utilization and higher energy density.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A solid electrode comprising:
particles of an electroactive material;
a solid electrolyte comprising particles of an ionic compound having at least one halogen element;
a conductive carbon;
a coating deposited on the particles of the electroactive material, the particles of the solid electrolyte, or a combination thereof, the coating including:
a first layer comprising a metal halide, a metal sulfide, a metal phosphide, a metal oxide, or a metal selenide;
a second layer comprising a metal halide, a metal sulfide, a metal phosphide, a metal oxide, or a metal selenide;
wherein the first layer is different than the second layer.

2. The solid electrode of claim 1, wherein the first layer of the coating is a metal halide layer deposited on the particles of the electroactive material, the particles of the solid electrolyte, or a combination thereof;
wherein the second layer of the coating is a metal sulfide layer, a metal oxide layer, or a metal selenide layer deposited on the first layer; and
the coating further includes a third layer comprising a metal phosphide layer deposited on the second layer.

3. The solid electrode of claim 2, wherein the metal halide comprises LiCl, LiBr, LiI, or LiF; the metal sulfide comprises Li₂S; and the metal phosphide comprises Li₃P.

4. The solid electrode of claim 1, wherein the coating is deposited on the particles of the electroactive material and the particles of the solid electrolyte.

5. The solid electrode of claim 1, wherein the coating has a thickness of about 0.1 nm to about 100 nm.

6. The solid electrode of claim 1, wherein the ionic compound comprises an argyrodite-type inorganic solid electrolyte.

7. The solid electrode of claim 6, wherein the argyrodite-type inorganic solid electrolyte has a formula of Li₂S—P₂S₅—LiX, Li₂S—YS_{1.5}—LiX, Li₂S—YS₂—LiX, Li₂S—P₂S₅—YS₂—LiX, or Li₆PS₅X;
wherein:
X is F, Cl, Br, I, or a combination of two or more thereof; and
Y is Si, Ge, Sn, W, Sb, Al, As, B, Ga, or a combination of two or more thereof.

8. The solid electrode of claim 1, wherein the particles of the electroactive material comprise sulfur, selenium, tellurium, metal sulfide, metal selenide, metal fluoride, or a combination of two or more thereof.

9. The solid electrode of claim 1, wherein the particles of the electroactive material comprise tin, silicon, germanium, phosphorus, antimony, bismuth, lead, graphite, hard carbon, lithium titanate, or a combination of two or more thereof.

10. The solid electrode of claim 1, wherein the conductive carbon comprises a first carbon phase and a second carbon phase;
wherein the first carbon phase includes graphite, graphene, reduced graphene oxide, carbon black, a metal-organic framework, carbon spheres carbon nanotubes, carbon aerogel, or carbon nanofibers;
wherein the second carbon phase includes carbon black, carbon nanotubes, carbon nanofibers, polypyrrole, polyaniline, poly(3,4-etheylenedioxythiophene), poly(3,4-ethylenedioxythiophene), or polystyrene sulfonate; and
wherein the first carbon phase is different than the second carbon phase.

11. An electrochemical cell comprising:
a first electrode comprising particles of an electroactive material, a first solid electrolyte comprising an ionic conducting compound with at least one halogen element, a conductive carbon, and a coating deposited on the particles of the electroactive material, the first solid electrolyte, or a combination thereof;
a second electrode;
a solid electrolyte membrane deposited between the first electrode and the second electrode, the solid electrolyte membrane comprising a second solid electrolyte; and
wherein the coating includes:
a first layer comprising a metal halide, a metal sulfide, a metal phosphide, a metal oxide, or a metal selenide;
a second layer comprising a metal halide, a metal sulfide, a metal phosphide, a metal oxide, or a metal selenide; and
wherein the first layer is different than the second layer.

12. The electrochemical cell of claim 11, wherein the ionic conducting compound comprises an argyrodite-type inorganic solid electrolyte.

13. The electrochemical cell of claim 11, wherein the second solid electrolyte comprises a perovskite, an anti-perovskite, a NASICON-type oxide, a garnet-type oxide, a thio-LISCON sulfide, a glass sulfide, an argyrodite-type inorganic solid electrolyte, a halide, a polymer, or a combination of two or more thereof.

14. The electrochemical cell of claim 11, wherein the particles of the electroactive material comprise sulfur, selenium, tellurium, metal sulfide, metal selenide, metal fluoride, or a combination of two or more thereof; and
wherein the second electrode comprises lithium, lithium-indium alloy, lithium-silicon alloy, lithium-tin alloy, lithium-germanium alloy, lithium-phosphorus alloy, lithium-antimony alloy, lithium-bismuth alloy, lithium-lead alloy, lithiated hard carbon, lithiated graphite, or a combination of two or more thereof.

15. The electrochemical cell of claim 11, wherein the particles of the electroactive material comprises tin, silicon, germanium, phosphorus, antimony, bismuth, lead, graphite, hard carbon, lithium titanate, or a combination of two or more thereof;
wherein the second electrode comprises:
a layered lithium nickel manganese cobalt oxide having a formula of
Li_{1+δ}NiₓMn_{y}Co₂O₂ where δ≥0 and x+y+z=1;
a layered lithium nickel cobalt aluminum oxide having a formula of
LiNiₓCo_{y}Al_{z}O₂ where x+y+z=1;
a spinel lithium nickel manganese oxide having a formula of LiNiₓMn₂₋ₓO₄ where 0≤x≤2;
LiFePO₄;
LiNiPO₄;
LiMnₓFe₁₋ₓPO₄;
LiCoPO₄; or
a combination of any two or more thereof.

16. A method of preparing a coated solid electrode material, the method comprising:
milling a mixture of an electroactive material comprising particles, a conductive carbon, and a solid electrolyte comprising at least one halogen element to produce the coated solid electrode material comprising a coating derived from decomposition products of the solid electrolyte, the coating deposited on the particles of the electroactive material, the solid electrolyte, or a combination thereof.

17. The method of claim 16, wherein milling comprises milling in a planetary mixer at a mixing speed of about 2000 rpm to about 5000 rpm for a mixing time of about 5 hours to about 10 hours.

18. The method of claim 16, further comprising compressing the coated solid electrode material into a cohesive mass.

19. The method of claim 16, wherein solid electrolyte comprises an argyrodite-type inorganic solid electrolyte and the coating includes:
a first layer comprising a metal halide, a metal sulfide, a metal phosphide, a metal oxide, or a metal selenide;
a second layer comprising a metal halide, a metal sulfide, a metal phosphide, a metal oxide, or a metal selenide; and
wherein the first layer is different than the second layer.

20. The method of claim 16, wherein milling the mixture comprises mixing the electroactive material, the solid electrolyte, and the conductive carbon in a weight ratio of about 23 wt. % electroactive material, 50 wt. % solid electrolyte, and 27 wt. % conductive carbon.
